(19) United States
(12) Patent Application Publication
(10) Pub. No.: US 2017/0111469 A1
(43) Pub. Date: Apr. 20, 2017

(54) METHOD FOR ASSIGNING DYNAMIC IDENTIFIER TO ELECTRONIC DEVICE AND DEVICE THEREOF

(71) Applicant: SAMSUNG ELECTRONICS CO., LTD., Suwon-si (KR)

(72) Inventors: Kashyap Kamal KISHORE, Noida (IN); Rajul GUPTA, Noida (IN)

(73) Assignee: SAMSUNG ELECTRONICS CO., LTD., Suwon-si (KR)

(21) Appl. No.: 15/293,969

(22) Filed: Oct. 14, 2016

(30) Foreign Application Priority Data
Oct. 15, 2015 (IN) 3330/DEL/2015

(51) Int. Cl. H04L 29/08; H04L 29/06; H04W 4/00

(52) U.S. Cl. CPC H04L 67/303; H04W 4/008; H04L 67/10; H04L 67/42; H04W 84/12

(57) ABSTRACT

A method for assigning an identifier is proposed. The method includes assigning an identifier to one of an electronic device and a connection offered by the electronic device, based on at least one of content offered by the electronic device, a service offered by the electronic device, and an application running on the electronic device. The method further includes transmitting, by the electronic device, discovery information to at least one additional device, the discovery information including the identifier of the one of the electronic device and the connection offered by the electronic device.

### CROSS-REFERENCE TO RELATED APPLICATION

This application claims priority from Indian Patent Application No. 3330/DEL/2015, filed on Oct. 15, 2015 in the Indian Patent Office, the entire disclosure of which is incorporated herein by reference.

### BACKGROUND

1. Field

Methods and apparatuses consistent with exemplary embodiment relate to contents and services sharing in communication systems.

2. Description of Related Art

With the advent of smart devices and the Internet of things (IOT), more devices are interconnected with each other and the propagation of information is as easy and effortless as ever. Wi-Fi standards, which have been a major guiding influence on similar wireless technologies such as Bluetooth, Near Field Communication (NFC), etc., have empowered smart devices to create ad-hoc networks as well as to use the conventional methods of connecting with existing local area networks (LAN), wide area networks (WAN), and the Internet.

In a quest to meet the contemporary demands and, at the same time, usher in the new era of communication technologies, the Wi-Fi standards have introduced new concepts and features, notably “Wireless Multimedia Extensions,” “Wi-Fi Protected Setup,” “Wi-Fi Passpoint,” “WiGig CERTIFIED,” “WiFi Direct,” and “WiFi Miracast.”

Traditionally, the Wi-Fi standards have mainly worked upon peer-to-peer content streaming/sharing (e.g., WiFi Miracast, WiFi Direct, etc.). These concepts utilize the already existing Wi-Fi infrastructure. There are independent programs which have implemented the content streaming with their own protocols and applications. The Wi-Fi standards themselves are not rigid to the definition of their existing peer content streaming/sharing. Indeed, they have now extended the definition to encompass multi-connections as well as the conventional peer arrangement.

The user requirement and enhancement of the existing Wi-Fi feature set insinuates that in a near future there will be multi-connection options. This means the content and data will be available for sharing with other devices. Infrastructure-wise, there is no limitation to implementing these multi-connect options.

Broadcasting information to nearby clients is increasingly becoming an essential feature at public places. At airports, markets, etc., there will be more and more information being broadcast (e.g., flight schedule, market map, etc.). As information broadcasting becomes more prevalent, filtering to find the relevant information provider may be inconvenient for the user.

However, in a wireless environment when there is no connection between host and client, only broadcasted device names are observed by the client in available device list. Before a connection is established between a host and client wireless devices, there are some protocol-based steps which have to be followed for any meaningful communication could start. But until then, no information may be communicated between the host and the clients—including information about what service/content the host wireless device is currently offering.

Thus, with the current technology, when a user enters an area where there are devices offering some service or content via Wi-Fi, Wi-Fi Direct, Bluetooth, etc., the user will only be able to see some static device names with no information about what is offered or shared by the available devices. Thus, the content or service is discovered only after the establishment of a connection.

Presently, there is no information available about what is being offered by the hosts, and the average time it takes to search and connect to the desired host is long. For example, if the user wants to connect to a host that provides Internet connectivity, and if there are a larger number of devices (e.g., access points), only one or few of which are providing the desired service/data, the process of connecting to the right host becomes a cumbersome task with regard to time and ease. For instance, in a real life scenario where there is N number of devices available in the proximity of a client with which this client can connect, it may take N number of attempts by the client to know what is being played or shared by all the available host devices. Now, as the number of available devices increases, at user level this becomes very cumbersome and the long list of available devices may frustrate the user and may cause the user to lose interest in using the services offered by the hosts.

Thus, it is desirable to be able to discover the content or service being offered before the establishment of a connection. Such technology can be potentially beneficial as the market for proximity-based, social networking applications, IOT, etc. continues to grow. The urgency in this field can be sensed from the fact that the Wi-Fi alliance has proposed WiFi Aware certification program, which requires content/service discovery prior to connection.

### SUMMARY

One or more exemplary embodiments provide a device and a method for dynamically assigning an identifier to an electronic device or a connection offered by the device.

According to an aspect of an exemplary embodiment, there is provided a method for implementation by an electronic device that forms part of a communication system and is configured to share content or service(s) with at least one additional device. The method may include assigning an identifier to one of an electronic device and a connection offered by the electronic device, based on at least one of: content offered by the electronic device, a service offered by the electronic device, and an application running on the electronic device. The method may further include transmitting, by the electronic device, discovery information to at least one additional device, the discovery information including the identifier of one of the electronic device and the connection offered by the electronic device.

According to an aspect of another exemplary embodiment, the electronic device may detect at least one of: content information pertaining to content being offered by the electronic device, service information pertaining to a service being offered by the electronic device, and application information pertaining to an application running on the electronic device. Based on at least one of the content information, the service information, and the application information, an identifier is provided to the electronic device or a connection offered by the electronic device.

According to an aspect of another exemplary embodiment, the electronic device detects at least one of a change in content being offered by the electronic device; a change a service offered by the electronic device; and a change in an application running on the electronic device. In response to detecting a change, the electronic device detects at least one of: content information pertaining to a changed content being offered by the electronic device, service information pertaining to a changed service being offered by the electronic device, and application information pertaining to a changed application running on the electronic device. Based on at least one of the content information, the service information, and the application information, identifier is provided to the electronic device or a connection offered by the electronic device.

According to an aspect of another exemplary embodiment, the electronic device may detect at least one of: content information pertaining to content being offered by the electronic device, service information pertaining to a service being offered by the electronic device, and application information pertaining to an application running on the electronic device. The electronic device detects a name of at least one additional device that that forms part of the communication system. Based on the name of the at least one additional device an identifier is provided to the electronic device or a connection offered by the electronic device such that the identifier does not overlap with the name of the at least one further device and is also based on at least one of the content information, the service information, and the application information.

### BRIEF DESCRIPTION OF DRAWINGS

The above and other aspects will become more apparent from the following detailed description of exemplary embodiments taken in conjunction with accompanying drawings, in which:

FIG. 1 illustrates an exemplary communication system including a discovering device and a plurality of electronic devices, each transmitting a corresponding static identifier as part of the discovery information;

FIG. 2 illustrates an exemplary communication system including a discovering device and a plurality of electronic devices, where one of the electronic devices transmits a dynamic identifier as part of the discovery information;

FIG. 3 illustrates a flow chart of a method of assigning a dynamic identifier in accordance with an exemplary embodiment;

FIG. 4 illustrates a flow chart of a method of dynamic nomenclature in accordance with another exemplary embodiment;

FIG. 5 illustrates a flow chart of a method of assigning a dynamic identifier in accordance with another exemplary embodiment;

FIG. 6 illustrates a flow chart of a method of assigning a dynamic identifier in accordance with yet another exemplary embodiment;

FIG. 7 illustrates a block diagram of an electronic device implementing an exemplary embodiment;

FIG. 8 illustrates an assignment of a dynamic identifier based on electronic program guide data as implemented by a television set in accordance with an exemplary embodiment;

FIG. 9 illustrates an assignment of a dynamic identifier based on metadata of the content as implemented by a Wi-Fi Direct-enabled device in accordance with an exemplary embodiment;

FIG. 10 illustrates a flow chart for deriving a dynamic identifier in accordance with an exemplary embodiment;

FIG. 11 illustrates a flow chart for deriving a dynamic identifier in accordance with another exemplary embodiment;

FIG. 12 illustrates a communication system that includes a plurality of electronic devices sharing content/service and a device that requests content or service;

FIG. 13 illustrates how a dynamic identifier may be automatically updated based on a change in the content being shared;

FIG. 14 illustrates a beacon frame as may be transmitted by a Wi-Fi device according to an exemplary embodiment;

FIG. 15 illustrates a scenario in which a dynamic identifier may be used for queue management in public places such as restaurants, hospitals, banks, etc.;

FIG. 16 illustrates another scenario in which a dynamic identifier may be used to disseminate information; and

FIG. 17 illustrates still another scenario in which devices may be searched and filtered based on dynamic identifiers received.

### DETAILED DESCRIPTION

The following detailed description is provided to assist the reader in gaining a comprehensive understanding of the methods, apparatuses, and/or systems described herein. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the invention relates. Various changes, modifications, and equivalents of the systems, apparatuses, and/or methods described herein will be apparent to those of ordinary skill in the art. The progression of processing steps and/or operations described is an example; however, the sequence of steps and/or operations is not limited to that set forth herein and may be changed as is known in the art, with the exception of steps and/or operations necessarily occurring in a particular order. In addition, descriptions of well-known functions and constructions may be omitted for increased clarity and conciseness.

It will be understood by those skilled in the art that the foregoing general description and the following detailed description are exemplary and explanatory of the invention and are not intended to be restrictive thereof. The word “exemplary” is used herein to mean “serving as an example or illustration.” Any aspect or design described herein as “exemplary” is not necessarily to be construed as preferred or advantageous over other aspects or designs.

Reference throughout this specification to “an aspect,” “another aspect,” or similar language means that a particular feature, structure, or characteristic described in connection with the embodiment is included in at least one embodiment of the present disclosure. Thus, the phrase “in an embodiment,” “in another embodiment,” or similar language throughout this specification may, but do not necessarily, refer to the same embodiment.

The terms “comprises,” “comprising,” “includes,” “including” and any other variations thereof, are intended to cover a non-exclusive inclusion, such that a process or method that comprises a list of steps may not only include those steps but may include other steps not expressly listed or inherent to such process or method. Similarly, one or more devices or sub-systems or elements or structures or components proceeded by “comprises” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this disclosure belongs. The system, methods, and examples provided herein are illustrative only and not intended to be limiting.

Further, skilled artisans will appreciate that elements in the figures are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those of ordinary skill in the art having benefit of the description herein.

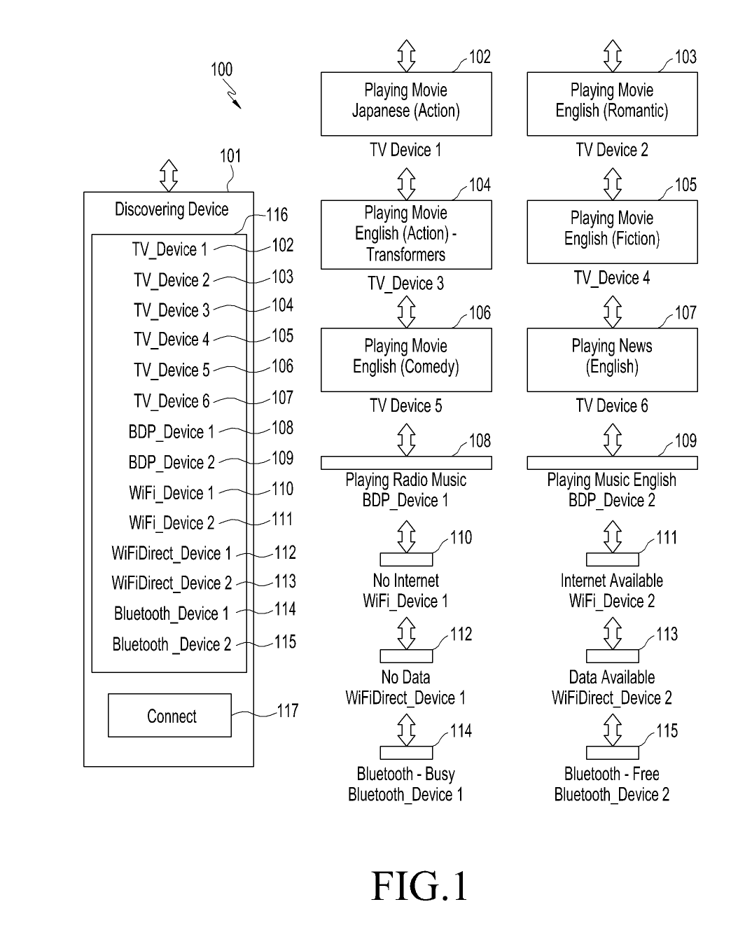

FIG. 1 illustrates an exemplary communication system including a discovering device and a plurality of electronic devices, each transmitting a corresponding static identifier as part of the discovery information. As shown in FIG. 1, a communication system 100 may include a discovering device 101 and a plurality of electronic devices 102-115 that can provide content or services. By way of example, the plurality of electronic devices may include televisions (TVs) having identifiers of TV Device 1 (102), TV Device 2 (103), TV Device 3 (104), TV Device 4 (105), TV Device 5 (106), and TV Device 6 (107); audio players having identifiers of BDP Device 1 (108) and BDP Device 2 (109); WiFi-enabled devices having identifiers of WiFi Device 1 (110) and WiFi Device 2 (111), WiFi Direct-enabled devices having identifiers of WiFi Direct Device 1 (112) and WiFi Direct Device 2 (113); and Bluetooth devices having identifiers of Bluetooth Device 1 (114) and Bluetooth Device 2 (115).

The term “identifier,” as used herein, may refer to one of a name, a nickname, an identification, a label, a number, etc. that can distinguish one device from another. For example, an identifier may be an alphanumeric string that is recognizable by a machine. An identifier is preferably unique to the device to which the identifier is attached but does not need to be. The identifier can be unique within a given namespace. An identifier may correspond to, for example, a serial number, a model number, a device type, a device name, an address, a service set identifier (SSID), a network name, or any combination thereof.

TV Device 1 (102) is illustrated in FIG. 1 as rendering a Japanese action movie, TV Device 2 (103) is illustrated as rendering an English-language romantic movie, TV Device 3 (104) is illustrated as rendering an English-language action movie (e.g., Transformers), TV Device 4 (105) is illustrated as rendering an English-language fiction movie, TV Device 5 (106) is illustrated as rendering an English-language comedy movie, and TV Device 6 (107) is illustrated as rendering an English-language news broadcast. BDP Device 1 (108) is illustrated as playing a radio broadcast while BDP Device 2 (109) is illustrated as playing an English-language song. WiFi Device 1 (110) is illustrated as temporarily not having an Internet connection, and WiFi Device 2 (111) is illustrated as having an Internet connection. WiFi Direct Device 1 (112) is illustrated as temporarily not having data for sharing, and WiFi Direct Device 2 (113) is illustrated as having data for sharing. Bluetooth Device 1 (114) is illustrated as temporarily b-mg busy while Bluetooth Device 2 (115) is illustrated as being free (i.e., available for communication).

Assuming that the discovering device 101 is able to discover all of the plurality of electronic devices 102-115, the identifiers of the plurality of electronic device will be displayed in a display area 116 of the discovering device 101. The discovering device 101 allows a user thereof to select any of the discovered electronic devices and connect 117 to the same.

In a traditional environment where the content or service to be shared is discovered only after the establishment of a connection, the user at the discovering device may be able to merely see the static device names of the plurality of electronic devices and does not receive any information about what is offered/shared by each of the plurality of electronic device.

This problem may, however, be solved by transmitting discovery information by an electronic device, where the discovery information includes a dynamic identifier assigned to the electronic device or a connection offered by the electronic device based on the content offered by the electronic device, service offered by the electronic device, and/or an application running on the electronic device. The term “dynamic” as used herein may signify that the identifier may change after the identifier has been already generated according to the content or service that is offered by the device, especially without an additional human input or intervention.

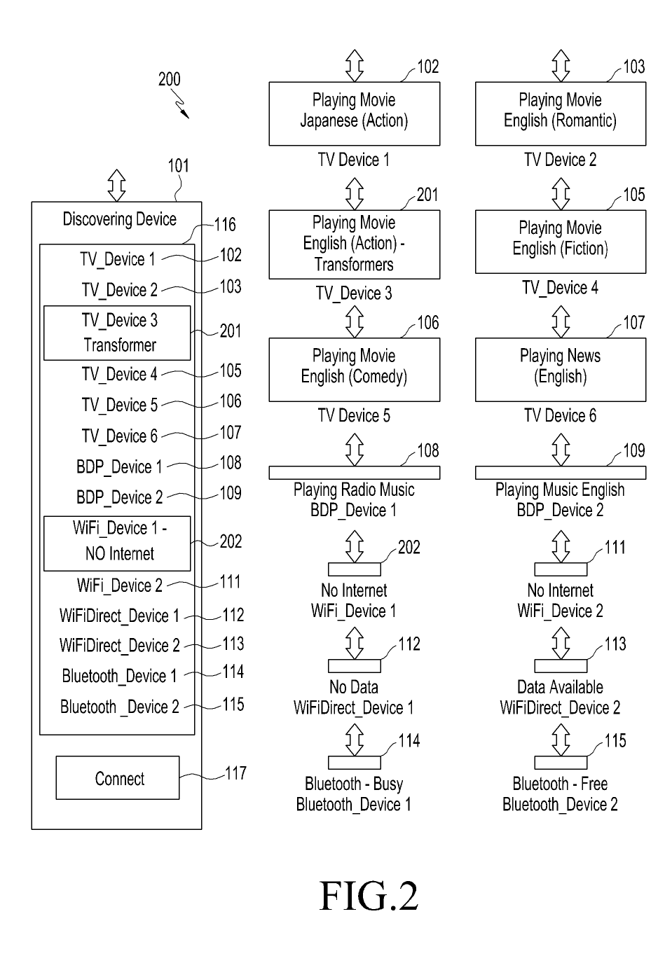

FIG. 2 illustrates an exemplary communication system including a discovering device and a plurality of electronic devices, where one of the electronic devices transmits a dynamic identifier as part of the discovery information. For the purposes of illustration, consider a communication system 200 as illustrated in FIG. 2. The communication system 200 is substantially similar to the communication system 100 of FIG. 1 with the difference being in respect to WiFi Device 1 (which is now referred to as 202). In FIG. 2, WiFi Device 1 (202) transmits discovery information that includes a dynamic identifier (as opposed to a device name). The dynamic identifier can be, for example, “TV_Device 3_Transformers” for TV_Device 3 (104). The dynamic identifier may pertain to any of a dynamic identifier assigned to the WiFi Device 1 (202) or a dynamic identifier assigned to a connection offered by the WiFi Device 1 (202). The dynamic identifier may be based on content offered by the WiFi Device 1 (202), a service offered by the WiFi Device 1 (202, or an application running on the WiFi Device 1 (202).

Although WiFi Device 1 (202) is capable of offering an Internet service, WiFi Device 1 (202) may be temporarily not in a position to provide the Internet connectivity. Thus, the WiFi Device 1 (201) may transmit dynamic identifier of “WiFi Device 1—NO INTERNET.” Because of the above, the discovering device 101 may render the dynamic identifier of WiFi Device 1 (i.e., “WiFi Device 1—NO INTERNET”) in the display area 116 of the discovering device 101. This provides a user of the discovering device with additional information about the WiFi Device 1 (202) and helps the user to make the decision to stay away from WiFi Device 1 (202) when trying to establish an Internet connection.

Although only WiFi Device 1 (201) is illustrated as transmitting discovery information including a dynamic identifier in FIG. 2, as more devices discovery information with dynamic identifiers, the user at the discovery device 101 may get a clearer picture of the content/services being offered by s devices and hence, can make a more informed decision as to connection.

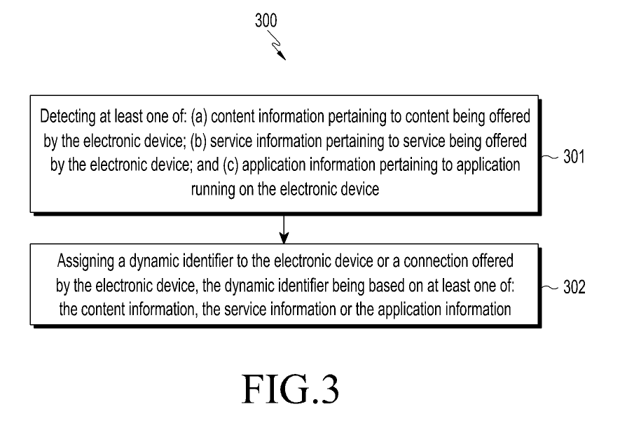

illustrates a flow chart of a method of assigning a dynamic identifier in accordance with an exemplary embodiment. In FIG. 3, a method of assigning a dynamic identifier (300) to an electronic device or a connection offered by the electronic device is shown. The method 300 includes detecting at least one of (a) content information pertaining to content being offered by the electronic device, (b) service information pertaining to service being offered by the electronic device, and (c) application information pertaining to application running on the electronic device (301).

The method 300 further includes assigning a dynamic identifier to the electronic device or a connection offered by the electronic device, the dynamic identifier being based on at least one of: the content information, the service information, or the application information (302).

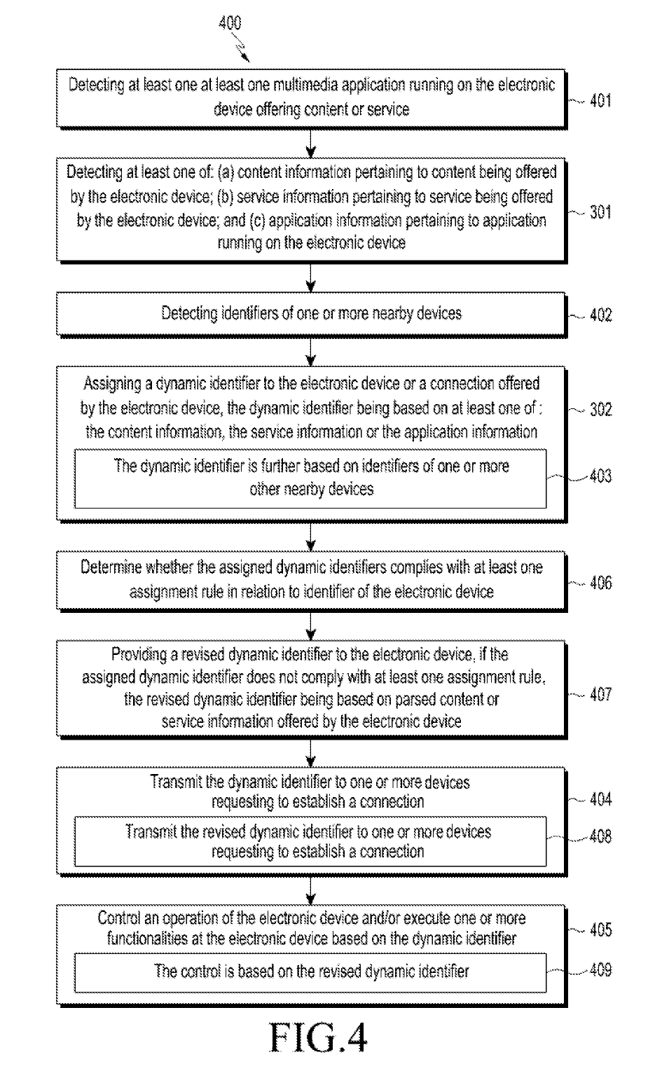

The method 300 in FIG. 3 can be supplemented with one or more additional steps as illustrated in FIG. 4.

In particular, in addition to the steps of detecting (301) and assigning (302), the method of assigning a dynamic identifier (400) may further include detecting at least one red application running on the electronic device (401). In some instances, based on the nature of the multimedia application running on the device, it may be possible to detect the content information, the service information or the application information. Thus, detection of the multimedia application running on the device can assist in easily detecting the content information, the service information, or the application information.

In particular, the identifier assigned to an electronic device or a connection offered by the electronic device, which is part of a communication system, may be unique so as to avoid overlapping with the identifiers of any remaining devices. Thus, according to an exemplary embodiment, the method 400 may further include detecting identifiers of one or more other nearby devices (402), and assigning the dynamic identifier to the electronic device (302) based on the identifiers of the one or more other devices (403). As used herein, “nearby” may mean, for example, being located in the same room, within the same local network, or within line of sight of each other. In other words, a nearby device may be located vi thin a threshold distance away from another device.

Once the dynamic identifier is assigned, the identifier of the electronic device may be transmitted to one or more devices requesting establish a connection with the electronic device (404). Alternatively, once the dynamic identifier is assigned, an operation of the electronic device may be controlled and/or one or more functionalities may be executed at the electronic device, based on the identifier of the electronic device (405), and optionally based on the identifier(s) of other nearby devices.

In some embodiments, there may be one or more rules or guidelines for the assignment of the identifier of the electronic device. For example, the assignment rules may prescribe one or more conditions that must be satisfied by the identifier assigned to the electronic device. The conditions may include, for example, (a) a minimum number of characters contained in the identifier, (b) a maximum number of characters contained in the identifier, (c) presence of special characters in the identifier, (d) absence of special characters in the identifier, etc. Thus, in case there is prescribed guidelines relating to the identifier of the electronic device, the method 400 may further include the steps of: determining whether the identifier assigned to the electronic device complies with at least one assignment rule in relation to the identifier of the electronic device (406); and assigning a revised identifier to the electronic device, if the identifier assigned to the electronic device does not comply with at least one assignment rule (407). According to an exemplary embodiment, the revised identifier may be determined by parsing content information, service information, and/or the application information. In another exemplary embodiment, the revised identifier may be determined by expanding the content information, service information, or the application information. In yet another exemplary embodiment, the revised identifier may be determined by replacing one or more characters in the original identifier with replacement character(s).

In a case where a revised identifier is assigned to the electronic device, the step of transmitting the dynamic identifier (404) may be modified to transmit the revised identifier of the electronic device to one or more devices requesting to establish a connection with the electronic device. Alternatively, once the revised identifier is provided to the electronic device, the step of controlling (405) may be modified so as to control an operation of the electronic device and/or execute one or more functionalities at the electronic device, based on the revised identifier of the electronic device (409). Examples of controlling the operation of electronic device and/or executing one or more functionalities include, but are not limited to, executing a command chosen at the electronic device, displaying a pop up, etc. According to an exemplary embodiment, when a receiving device has selected a movie (e.g., “The Matrix”) and if the movie is being broadcasted by a transmitting device with a device name having the phrase, “The Matrix,” then the receiving device may display a pop-up message indicating the name of the movie.

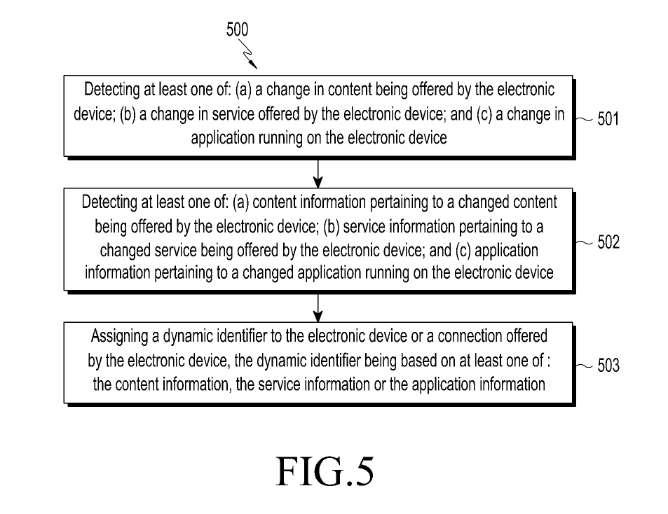

Because the content being offered by the electronic device, the service being offered by the electronic device, or the application running on the electronic device can change at any point in time, and because the identifier is dependent upon content information, the service information, or the application information, there is provided a method 500 as illustrated in FIG. 5.

FIG. 5 illustrates a flow chart of a method of assigning a dynamic identifier in accordance with another exemplary embodiment. The method 500 may include detecting at least one of (a) a change in content being offered by the electronic device, (b) a change in service offered by the electronic device, and (c) a change in application running on the electronic device (501).

The method 500 may further include, in response to detecting a change, detecting at least one of (a) content information pertaining to changed content being offered by the electronic device, (b) service information pertaining to a changed service being offered by the electronic device; and (c) application information pertaining to changed application running on the electronic device (502).

Similar to FIG. 3, the method 500 may further include assigning a dynamic identifier to electronic device or a connection offered by the electronic device, the dynamic identifier being based on at least one of: the content information, the service information, and the application information (503). Because the content information, the service information, and the application information now pertain respectively to changed content being offered by the electronic device, a changed service being offered by the electronic device, and a changed application running on the electronic device, the dynamic identifier assigned to the electronic device or the connection offered by the electronic device may thus be updated automatically.

The method 500 of FIG. 5 may be supplemented with one or more additional steps as illustrated in FIG. 4. Particularly, the method 500 may further include one or more of operations 401, 402, 403, 404, 405, 406, 407, 408, and 409 of FIG. 4.

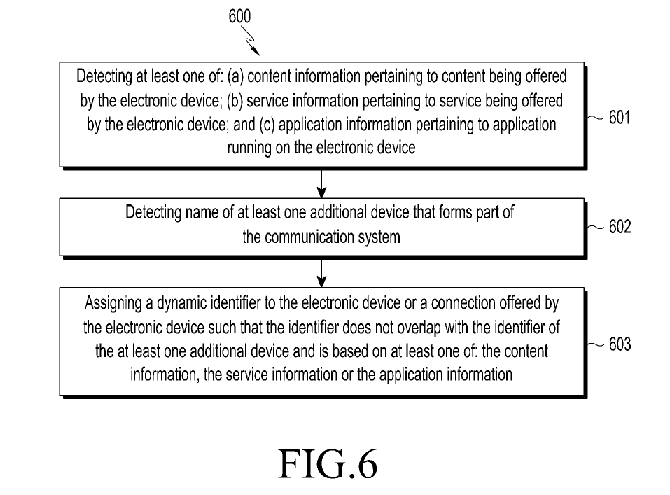

Because an electronic device offering the content or the service may form part of a communication system which may include one or more additional devices offering content or service, in an exemplary embodiment, there is provided a method 600 as illustrated in FIG. 6.

FIG. 6 illustrates a flow chart of a method of assigning a dynamic identifier in accordance with another exemplary embodiment. The method may elude detecting at least one of (a) content information pertaining to a changed content being offered by the electronic device, (b) service information pertaining to a changed service being offered by the electronic device, and (c) application information pertaining to changed application running on the electronic device (601).

The method 600 may further include detecting a name (i.e., identifier) of at least one additional device that that forms part of the communication system (602). The steps 601 and 602 may be performed in any order or concurrently. The method 600 further include assigning a dynamic identifier to the electronic device or a connection offered by the electronic device such that the assigned identifier does not overlap with the identifiers of the additional device(s), and the dynamic identifier is based on at least one of: the content information, the service information or the application information (603).

For example, the electronic device identifies “appropriate metadata” about the content/service/application the device is providing at a given tune. The “appropriate metadata” may be raw metadata or processed metadata. The “appropriate metadata,” optionally along with a static name of the device or a connection offered by the device, is used for generating a meaningful string for the dynamic identifier. The meaningful string is generated such that the same is compliant with one or more assignment rules for the identifier of the electronic device. Also, the meaningful string is generated such that the same is not in conflict with any other existing devices in the communication system.

Now, in the case of an electronic device sharing content, the content information can be raw metadata about the content or processed metadata about the content or raw data pertaining to the application running on the electronic device or processed data pertaining to the application running on the electronic device. On the other hand, in the case of an electronic device providing a service, the service information can be raw data pertaining to the type of service or processed data pertaining to the type of service or raw data pertaining to the application running on the electronic device or processed data pertaining to the application running on the electronic device.

In some exemplary embodiments, additional information such as a location of the electronic device, priority-related information, a type of electronic device, a version of software installed on the electronic device, etc. can also be used for generating the “appropriate metadata.”

Details about the device and the construction of the device implementing the exemplary embodiments will be provided below.

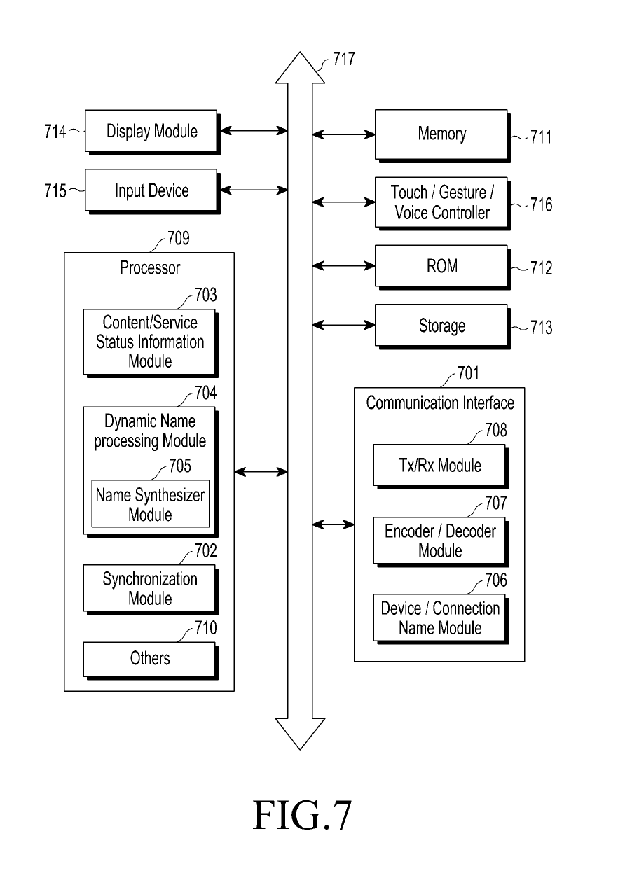

FIG. 7 illustrates a block diagram of an electronic device 700 that may implement an exemplary embodiment. The device 700 may include a communication interface 701 for transmitting discovery information about the electronic device to at least one other device. According to an aspect of an exemplary embodiment, the discovery information may include a dynamic identifier assigned to the electronic device or a connection offered by the electronic device. The assigned dynamic identifier is based on at least one of: content offered by the electronic device; a service offered by the electronic device; and an application running on the electronic device.

The device 700 may further include a synchronization module 702 for detecting at least one of (a) a multimedia application running on the electronic device, the multimedia application offering the content or the service, (b) a change in content being offered by the electronic device, (c) a change in service offered by the electronic device, and (d) a change in application running on the electronic device. The synchronization module 702 is further adapted to generate a corresponding trigger based on the detection. The device 700 may further include a content/service status information determining module 703 in operational interconnection with the synchronization module 702 for receiving a trigger therefrom and for generating at least one of content information pertaining to content offered by the electronic device, service information pertaining to service offered by the electronic device, and application information pertaining to application running on the electronic device.

The device 700 may further include a dynamic name processing module 704, which includes a name synthesizer module 705. The dynamic name processing module 704 may be in operational interconnection with the content/service status information determining module 703 or receiving therefrom at least one of the content formation, the service information, or the application information and providing a dynamic identifier to the electronic device or a connection offered by the electronic device.

The communication interface 701 may include a device/connection name module 706 for transmitting discovery information about the electronic device to at least one other device. The device/connection name module 706 may be further adapted to receiving and detecting a device or connection name of one or more nearby devices. The device/connection name module 706 may be in operational interconnection with the dynamic name processing module 704 for providing to the dynamic name processing module 704 the device or connection name of one car more nearby devices thus detected.

The communication interface 701 may additionally include an encoder/decoder module 707. While transmitting, the encoder/decoder module 707 performs the encoding of the message being transmitted while during receiving, the encoder/decoder module 707 performs a decoding operation. The communication interface 701 further includes a transmitting/receiving module 708 for transmitting or receiving.

One or more of the synchronization module 702, the content/service status information module 703, and the dynamic name processing module 704 may form part of a processor 709. The processor 709 may include one or more other modules 710 for performing other operations customary to the electronic device. The electronic device may additionally include a memory 711 (e.g., a random access memory (RAM) or other dynamic storage device), wherein the memory stores information to be used by the processor 709. The memory 711 may store temporary information. The electronic device 700 may include a read-only memory (ROM) 712 for storing static information for the processor 709, or other static storage device. Also, the electronic device 700 may include the storage unit 713, for example, a magnetic disk or optical disk that stores information.

In order to display information, the electronic device 700 may include the display unit 714 (e.g., a cathode ray tube (CRT), a light-emitting display (LED), or a liquid crystal display (LCD)) connected to the processor 709. The electronic device 700 further includes input device 715, including alphabet keys, number keys, and other keys, which may be connected to the processor 709. The input device 715 may be included in the electronic device 700. Another type of user input device may be the touch/gesture/voice controller 716 for swipe, pattern, voice recognition, or a cursor direction key for transmitting an input to the processor 709 and controlling cursor movement on the display unit 714. Alternatively, the input device 715 may be included in the display unit 714, for example as a touch screen. Further, the various modules of device 700, as described above, communicate via a bus 717.

In addition, the device configured to implement various exemplary embodiments may include a content/service status information determining module for detecting at least one of (a) content information pertaining to content offered by the electronic device, (b) service information pertaining to service offered by the electronic device, and (c) application information pertaining to application running on the electronic device; and a dynamic name processing module for providing a dynamic identifier to the electronic device or a connection offered by the electronic device, the dynamic identifier being based on at least one of: the content information, the service information, or the application information. The device as described above further includes a communication interface for transmitting discovery information about the electronic device to at least one other device.

On the other hand, a device configured to implement the method as illustrated in FIG. 5 may include a synchronization module for detecting at least one of (a) a change in content being offered by the electronic device; (b) a change in service offered by the electronic device; and (c) a change in application running on the electronic device. The device further includes a content/service status information determining module being in operational interconnection with the synchronization module for detecting at least one of (a) content information pertaining to a changed content being offered by the electronic device, (b) service information pertaining to a changed service being offered by the electronic device, and (c) application information pertaining to changed application running on the electronic device. The device further includes a dynamic name processing module being in operational interconnection with the content/service status information determining module for providing a dynamic identifier to the electronic device or a connection offered by the electronic device, the dynamic identifier being based on at least one of: the content information, the service information and the application information. In some circumstances, there may be one or more guidelines or rules related to the identifier of the electronic device. A guideline for assigning an identifier may prescribe one or more conditions or predefined rules which must be satisfied by the identifier provided to the electronic device. For example, the conditions/predefined rules could relate to number of letters to be used for identifier, etc. In another example, user interests could also be taken into account for generating an identifier. For practical reasons, the device name is passed on to connection name and the conditions/predefined rules apply further. The device may further include a communication interface for transmitting discovery information about the electronic device to at least one other device.

According to another exemplary embodiment, a device configured to implement the method as illustrated in FIG. 6 may include a content/service status information determining module for detecting at least one of (a) content information pertaining to content being offered by the electronic device; (b) service information pertaining to service being offered by the electronic device; and (c) application information pertaining to application running on the electronic device. The device further includes a device/connection name module for detecting name of at least one other device that that forms part of the communication system. The device further includes a dynamic name processing module in operational interconnection with the content/service status information determining module and the device/connection name module for providing a dynamic identifier to the electronic device or a connection offered by the electronic device such that the same does not overlap with the identifier of the at least one other device and the dynamic identifier is based on at least one of: the content information, the service information, or the application information. The device furthermore includes a communication interface for transmitting discovery information about said electronic device to at least one other device.

In the following paragraphs, some of the implementations of the method and device are described in detail for the purposes of illustration. It may however, be noticed that the implementations described below are merely for the purposes of illustration and are not intended to limit the scope of the claims.

Each of the components and elements illustrated in FIG. 7 may be implemented with hardware, software, or a combination thereof. For example, each of the components shown in FIG. 7 may be implemented by one or more processors and a memory storing instructions which, when executed by the one or more processors, may perform respective operations and functions of the elements as discussed above.

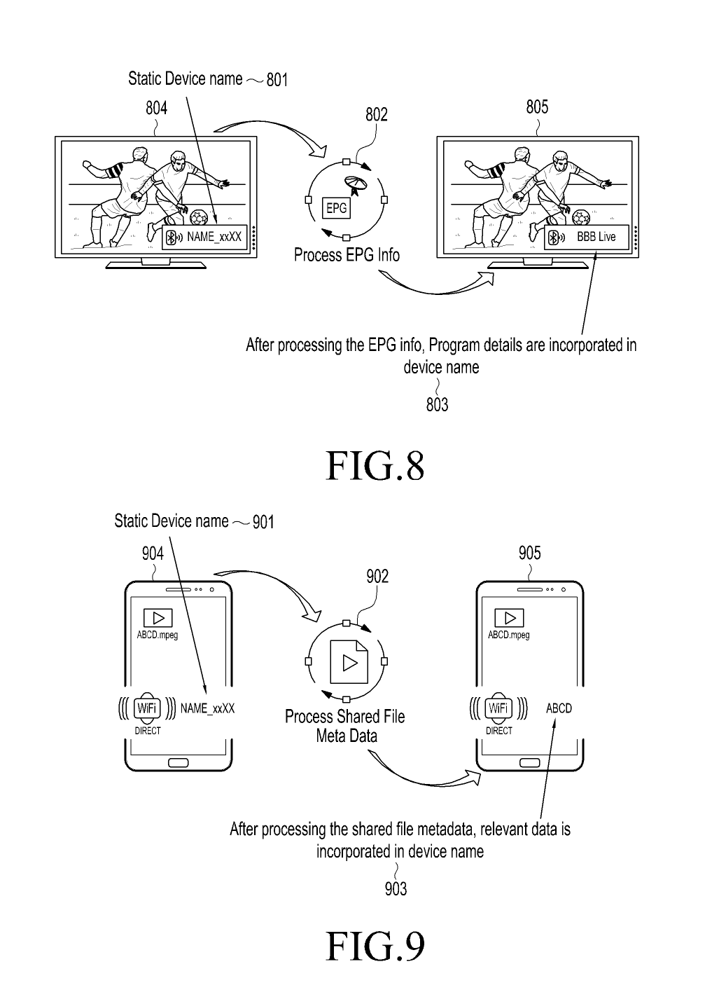

FIG. 8 illustrates an assignment of a dynamic identifier based on electronic program guide (EPG) data as implemented by a television that is capable of providing content to other devices over Bluetooth connectivity. As shown in FIG. 8, the television 804 is initially adapted to transmit a static name 801 generated for the television 804. On the other hand, once the method is implemented, the television processes the EPG information to generate a dynamic identifier (802). The dynamic identifier, which is dependent upon the content being made available by the television 805 to other devices over the Bluetooth connectivity, is provided (803) to the television 805.

FIG. 9 illustrates an assignment of a dynamic identifier based on metadata of the content as implemented by a Wi-Fi Direct-enabled device in accordance with an exemplary embodiment. As shown in FIG. 9, a portable device which is capable of providing content to other devices over a Wi-Fi Direct connectivity. As shown ill FIG. 9, the portable device 904 may be initially adapted to transmit a static name 901. On the other hand, once the method is implemented, the portable device processes the metadata corresponding to the content which is available for sharing to generate a dynamic identifier (902). The dynamic identifier which is dependent upon the content being made available by the portable device 905 to other devices is provided (903) to the portable device 905.

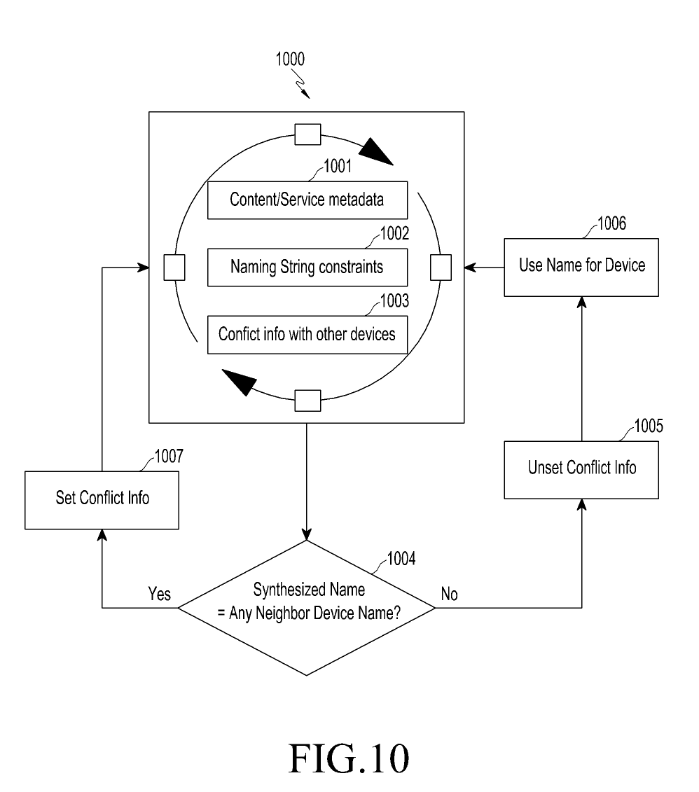

FIG. 10 illustrates a flow chart for deriving a dynamic identifier in accordance with an exemplary embodiment. In FIG. 10, a flow chart of the process 1000 adopted by the electronic device to generate a dynamic identifier is illustrated. The process 1000 includes receiving content/service metadata (1001), and generating a string based on the metadata. The string is tested for naming constraints (i.e., rules, guidelines, conditions, etc.) (1002), and in case the generated string satisfies the naming constraints, conflict information with other device is checked (1003). By way of a non-limiting example, the conflict information (e.g., a flag bit) may be pre-set as valid and in which case, a check is performed to determine whether the generated string is the same as any nearby device's name (1004). In case the generated string is not equal to any nearby device's name, the conflict information is unset (1005) and the generated string is provided as the dynamic identifier of the device (1006). On the other hand, if it is determined that the generated string is equal to a nearby device's name, the conflict information is set as valid and the process returns to re-generating afresh string.

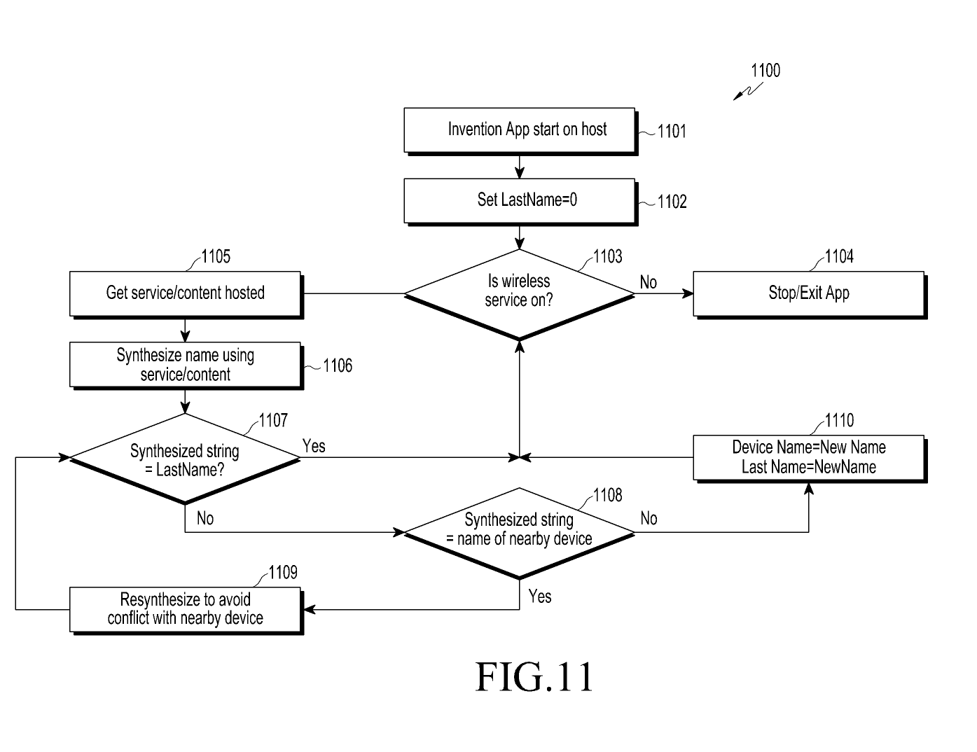

Assuming that the electronic device is a Wi-Fi-enabled device, a more detailed flow chart of the method is illustrated in FIG. 11, according to an aspect of an exemplary embodiment. The method 1100 is illustrated to be implemented by a software application residing on the Wi-Fi-enabled electronic device. The application is started (1101) and the application sets the variable “LastName” as a null value (e.g., 0) (1102). The application then detects whether the wireless service is ON (1103). If the wireless service is OFF, the application comes to a stop (1104). On the other hand, if the wireless application is ON, the service or content metadata is Obtained (1105), and a string or name is synthesized (i.e., generated) using the service/content metadata (1106). Thereafter, it is as to as to whether the synthesized string or name is equal to the variable “LastName” (1107). In case the synthesized string or name is equal to the variable “LastName,” the method returns to the step 1103. On the other hand, if the synthesized string or name is not equal to the variable “LastName,” it is determined as to whether the synthesized string or name is equal to a name of any of the nearby devices (1108).

If the synthesized string or name is equal to a name of a nearby device, a new string or name is re-synthesized (i.e., generated) (1109) so as to avoid conflict with nearby devices, and the process returns to the step 1107. On the other hand, if the synthesized string or name is not equal to any of the names of nearby devices, the variable “New Name” (i.e., synthesized string) is assigned to the variable “Device Name,” and the variable “LastName” is updated with the variable “New Name” (1110). Thereafter, the process returns to step 1103. In an exemplary embodiment, this new name (1110) may be stored locally on the device. More specifically, once the application sets the dynamic name, it will store the name in an operating system or a memory, or directly as connection name. If the device name is set, then connection name can be set by fetching the device name. For this purpose, a protocol specific application program interface (API) can be called to set the connection name.

In the method 1100, the status of the device may be continually checked to detect a change. According to another exemplary embodiment, the reassignment of identifiers may be event-based and may not require continuous checking of the device status. In this embodiment, whenever there is any change in the status of a monitored software application with respect to content or service, an event is triggered to synthesize the new device/connection name based on one or more of: naming constraints, protocol, user interest, nearby device names, etc. In one implementation, user can have an option to enable or disable the option of dynamic device naming in said software application. Further, the user may also add rules or his/her interests for setting the device name.

The above-mentioned exemplary embodiments are explained from the perspective of a single software application. However, it is possible to implement the exemplary embodiments with multiple applications, which may try to set the name simultaneously. In such a case, user or system defined priority may be utilized to resolve any naming conflicts. For this purpose, all such applications ca be assigned a static or dynamic priority and the name can be assigned priority according to the application generating the name. On the other hand, when the system is capable of offering multiple connections; the multiple connections can be created without prioritizing the applications. The multiple connections may be based on hardware characteristics/capabilities, or it could be based on software capabilities, such as creating multiple virtual connections with more than one dynamic connection names.

According to an exemplary embodiment, the application may allow broadcast of certain information as part or as a connection name to the other devices. In one example, a digital music player may use parameters such as artist name, movie name, or song name to generate a dynamic identifier. A music player application can be configured to provide one or more of these parameters to a connection module in the system, and the connection module may then embed one or more these parameters into the connection name. User can always switch on or off this feature. If desired, the user can set rules as per his/her preference.

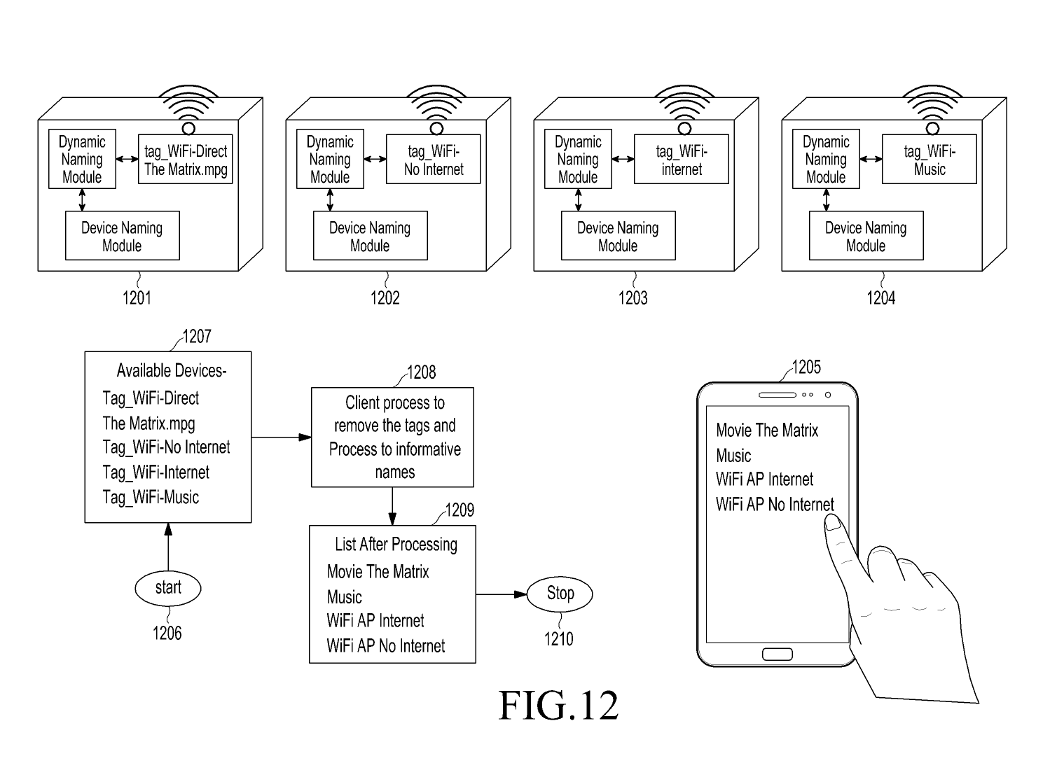

FIG. 12 illustrates a communication system that includes a plurality of electronic devices sharing content/service and a device that requests content or service. By way of example, FIG. 12 illustrates a network that includes 4 devices 1201, 1202, 1203 and 1204, each of which may share content, service, or connection with a device 1205, which is seeking content or a service. In particular, device 1201 is a Wi-Fi Direct-enabled device and is currently sharing the movie “The Matrix.” The device 1202 is a Wi-Fi-enabled device (e.g., wireless access point), which is currently not providing an Internet connection service. The device 1203 is a Wi-Fi-enabled device, which is currently offering Internet connectivity. The device 1204 is a Wi-Fi-enabled device, which is currently sharing music content. According to an aspect of an exemplary embodiment, devices 1201, 1202, 1203 and 1204 may transmit dynamic names (i.e., dynamic identifiers). By way of example, the Wi-Fi Direct-enabled device 1201 sharing the movie “The Matrix” may transmit a dynamic name “Tag_WiFi-Direct The Matrix.mpg”; the Wi-Fi-enabled device 1202 currently not offering Internet connectivity may transmit a dynamic name “Tag_WiFi-No Internet”; the Wi-Fi-enabled device 1203 currently providing an Internet connection may transmit a dynamic name “Tag_WiFi-Internet”; and the Wi-Fi-enabled device 1204 currently sharing music may transmit a dynamic name “Tag_WiFi-Music”.

The seeking device 1205 (i.e., client device that is requesting to establish a connection with another device) may commence a discovery process (1206), and receive details of the Available Devices (i.e., nearby devices that are available for communication) (1207). The seeking device 1205 may optionally perform a process of removing certain elements from the details of the Available Devices (1208). For example, the seeking device 1205 may choose to remove the portion “Tag_” from the received information. As part of post processing, the seeking device 1205 may render the dynamic names of the available devices (1209), and then stop the process (1210). Thus, the exemplary dynamic names thus rendered on the seeking device may be “Movie The Matrix,” “Music,” “WiFi AP Internet,” and “WiFi AP No Internet.” This enables the user at the seeking device 1205 at or before the time of connection to make a more informed decision in terms of which device to connect to.

In the aforesaid scenario, if the content or service being shared by the electronic device changes, the dynamic name provided to the electronic device may also change automatically so as to keep the user updated.

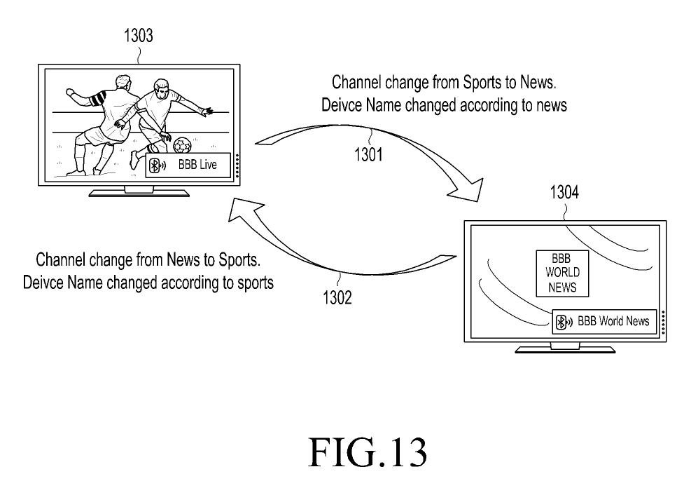

FIG. 13 illustrates how a dynamic identifier may be automatically updated based on a change in the content being shared. As used herein, the term “automatically” signifies that the dynamic identifier may change from one identifier to another identifier with little or no input from the user with regard to the timing or the content of the change. In other words, the device identifier may be spontaneously updated without the user specifically requesting the change or dictating what identifier should be used. As illustrated in FIG. 13, there is provided a television 1303 which is currently sharing a particular channel (“BBB Live”) via Bluetooth connectivity. Thus, the current dynamic name (i.e., dynamic identifier) of the television 1303 is set to “BBB Live.” If a user changes the channel from sports to news programming, the dynamic name of the television may also change accordingly (1301), and the new dynamic name of the television 1304 is rendered as “BBB World news.” If the channel changes from BBB World News to BBB Live, the dynamic name will once again change to BBB Live (1302).

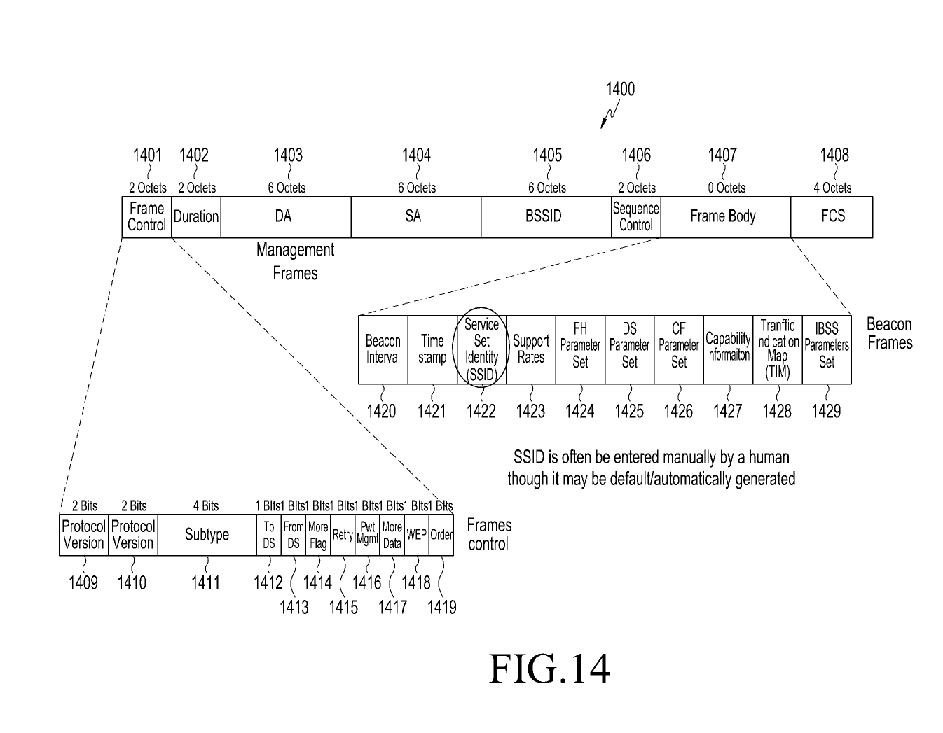

In one example, the device may be a Wi-Fi device as per Institute of Electrical and Electronics Engineers (IEEE) 802.11 standards. FIG. 14 illustrates a beacon frame that may be transmitted by a Wi-Fi device according to an exemplary embodiment. A frame 1400 may be an IEEE 802.11 media access control (MAC) frame, which includes frame controls, management frames, and beacon frames, where the service set identity (SSID) field 1422 can be used for transmitting the device/connection name. In this scenario, the Wi-Fi device may periodically broadcast 801.11 MAC management frames called “beacons” irrespective of the device's mode before a connection is established. The beacon frame may thus announce the presence of a nearby wireless station or a wireless local area network (WLAN). The beacon frame may include information about the configuration and capabilities of that network. As shown in FIG. 14, the beacon frames 1400 may include:
Frame Control 1401, details of which is provided in the following paragraphs;
Duration indication 1402 field, which serves two purposes—communicating duration and association ID. Depending on the frame type in a transmission this field may yield two entirely different pieces of information;
Destination address (DA) field 1403, which pertains to the MAC address of the station that is the final destination of the frame;
Source address (SA) field 1404, which pertains to the MAC address of the station that originated the frame;
Basic service set identifier (BSSID) 1405, which pertains to unique identifier for a particular basic service set (BSS);
Sequence control field 1406, which allows for a receiving station to eliminate duplicate received frames;
Frame body field 1407, details of which is provided in the following paragraphs; and
Frame check sequence (FCS) Field 1408, which contains a cyclic redundancy check (CRC) value to verify whether or not any errors occurred in the frame.

As per IEEE 802.11, the frame control 1401 in turn includes:
Protocol version 1409 for identifying the version of the IEEE 802.11 MAC protocol;
Frame type 1410 and sub type 1411, which identify the function of the frame and which other MAC header fields are present in the frame.
To distribution system (DS) field 1412 and From DS field 1413;
More fragments flag subfield 1414, which indicates that this frame 1400 is not the last fragment of a data or management frame;
Retry subfield 1415, which indicates whether the frame 1400 is transmitted for the first time or is a retransmission;
Power management subfield 1416, which may indicate the mobile station's power management state;
More data subfield 1417, which is used by an access point (AP) to indicate to a mobile station that there is at least one frame buffered at the AP for the mobile station;
Wired Equivalent Privacy (WEP) subfield 1418, which indicates that the frame body of MAC frame has been encrypted using the WEP algorithm; and
Order subfield 1419, which indicates that the content of the data frame was provided to the MAC with a request for strictly ordered service.

As per IEEE 802.11, the frame body field 1407 in turn may include:
Beacon interval 1420, which indicates the typical amount of time that elapses between beacon frame transmissions;
Timestamp 1421, which contains the value of the station's synchronization timer at the time that the frame was transmitted;
Service set identity (SSID) 1422, which carries the SSID of the IEEE 802.11 WLAN. A service set is a group of devices associated with a given WLAN. When the length of this subfield is zero, it means that the frame is broadcasted. The broadcast identity is used in probe request frames when the mobile station is attempting to discover all IEEE 802.11 WLANs in the device's vicinity.
Supported rates 1423, which identifies the rates supported by the station;
Frequency-hopping (FH) Parameter Set 1424, which contains parameters necessary to join a frequency-hopping;
Direct-Sequence (DS) Parameter Set 1425, which indicates the current channel;
Contention-Free (CF) Parameter Set 1426, which apprises all mobile stations about contention-free operation;
Capability information 1427, which identifies the capability of the station;
Infrastructure basic service set (IBSS) Parameter Set 1428, which contains the set of parameters necessary to support an IBSS. The information field contains the announcement traffic information message (ATIM) Window parameter; and
Traffic Indication Map (TIM) 1429, which carries information about frames that are buffered at the AP for stations in power saving modes of operation.

There is a need to let the information about the content/service reach the prospective clients without altering any existing standards thereby providing backward compatibility across all the legacy devices. In the legacy devices, irrespective of technology (e.g., Wi-Fi/wired/Bluetooth/near-field communication (NFC)), a human-readable identifier of the device (i.e., a device name) is stored in a configuration file. This configuration file may be processed to obtain a dynamic identifier and the same is used for transmission with other client devices. As part of implementation, there is provided a mechanism to dynamically detect information about the content/service being offered. Once the dynamic information about the content/service being offered has been obtained, an updated configuration file containing the same is generated. In response to the generation of the updated configuration file, new identifier may be created, and the new identifier is used for transmission with other client devices. This enables dynamic transmission of information about the content/service being offered by the device to reach the prospective client devices irrespective of transmission protocols/standards.

In an exemplary embodiment, while the transmitted dynamic device name enables a user at a seeking device (i.e., client) at or prior to the time of connection to connect with the appropriate device, further functionalities may be provided to the user at the seeking device or the same can be used for deriving other user-specific implementation. Some of those implementations are described herein below for the purposes of illustration.

By way of a first example, a software-based system may intelligently determine the naming of the identifier based on content/service information on host devices and present all the available host devices as a playlist/content list on the client devices. Thus, the process of selecting from the available devices at the client end is abstracted to a simple browsing experience through a list of available contents. The host software may embed additional tags or signatures in the name. Such names, when discovered by the client software, may be processed and be placed in a special service/content list viewed on the client device.

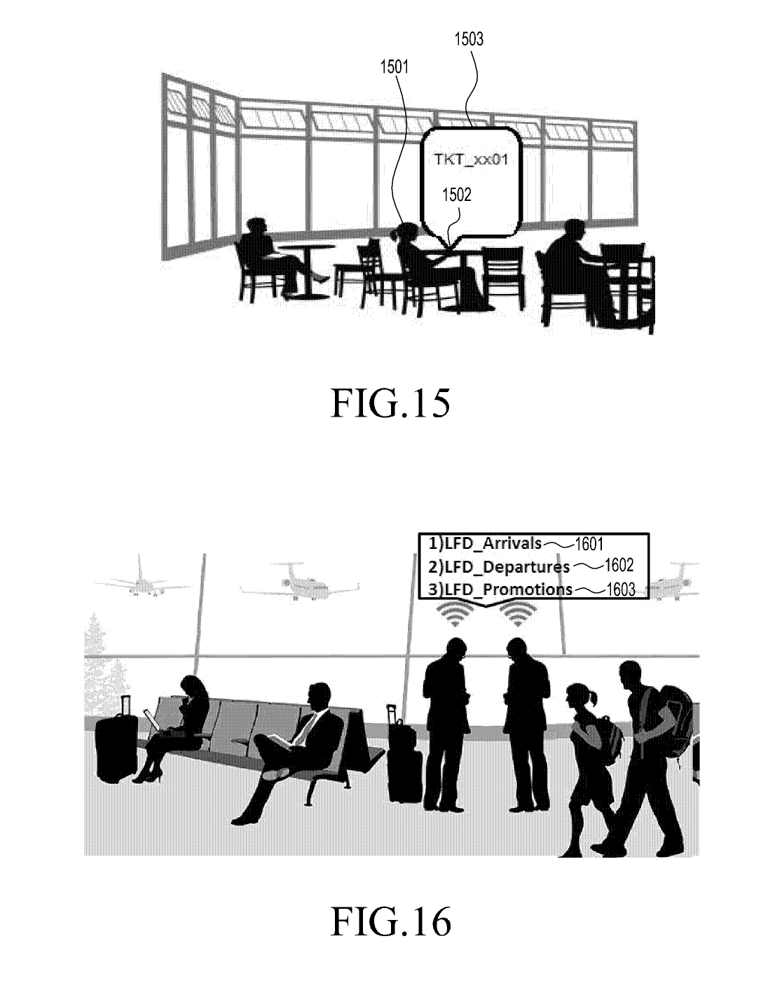

FIG. 15 illustrates a scenario in which a dynamic identifier may be used for queue management in public places such as restaurants, hospitals, banks, etc. For example, the various embodiments of the present disclosure may be used to display and indicate one's position in a queue based upon an order number, a ticket number, etc. As illustrated in FIG. 15, instead of or in addition to displaying the order number/ticket number on the display screen, the number can be appended to the name of a wireless device, such as a wireless access point (WAP). For example, a user 1501, who is waiting in a waiting area to pick up her coffee, may see the wireless device name on her handheld device 1502. As the order number/ticket number is appended to the wireless device's identifier, the user may be notified with the order number/ticket number 1503 currently being served on her hand-held device 1502. Thus, the user 1501 may check the present status of the queue without even having to connect her device 1502 to the WAP, which is broadcasting the queue status information through the WAP's dynamic identifier (e.g., via an SSID).

By way of a further example, consider a scenario in which there are provided two televisions, implemented with one or more exemplary embodiments of the present disclosure, in close proximity to each other. As both television sets share their dynamic identifiers with each other e.g., for the purposes of ensuring that their dynamic identifiers do not overlap with each other), these two televisions may thus share information about the content being displayed on then. In case the two televisions are playing different content, one or both of the televisions may automatically make a decision. One example of such a decision is reducing the sound volume level if the two television sets are playing different TV programs so that the sound output of different programs from different TVs do not create an unpleasant noise. Thus, based on the dynamic identifiers, an electronic device may control one or more parameters of the electronic device.

In yet another example, a seeking device (i.e., client) may transmit an information-based connection query to another electronic device (i.e., host or server) offering content or service. Through dynamic identifiers, the seeking device is able to obtain information about the service/content being provided by the other electronic device, and, by the same token, the server electronic device may obtain, from the client's name, such information as priority information, device type, software version information, etc. This enables the electronic device offering the content/service to more efficiently obtain and process the information pertaining to the seeking device.

In still another example, in areas such as airports where there are many information display units (e.g., monitors, signs, information booths, etc.), not all of the display units may be rendering information that is relevant to a nearby user. Taking an airport as an example, the departure information may not be displayed in every display unit of the airport. Thus, it may be advantageous to guide a passenger to the nearest display device that is currently rendering the departure information. Thus, the electronic device offering the appropriate content/service and the seeking device (e.g., a portable device carried by the passenger) may incorporate their global positioning system (GPS) locations into their respective dynamic identifiers. In such a case, the user of the seeking device (i.e. a passenger) may be provided with directions (e.g., go straight/left/right) or a map to the nearest display device (e.g., television, large format displays (LFD)) that is currently displaying the departure information. With multicast audio/video, the content played on one LFD/kiosk may be available to more than one client. Therefore, the passengers and customers may easily find and browse through the offered information around his environment.

In still yet another example, many public areas are provided with information kiosks or large format displays (LFD), which may display information about the layout of an area, building, or the like. In airports, for examples, large format displays may be used to disseminate information about arrivals, departures, available facilities, maps, shopping information, promotions, etc. However, the reach of the kiosks or the LFDs are limited to the audience who are within the visual range of the kiosks and the LFDs. However, by implementing one or more embodiments of the present disclosure, the kiosks/LFDs may transmit additional data pertaining to arrivals, departures, available facilities, a layout, shopping information, promotions, etc. as part of the kiosks' and LFDs' dynamic identifiers. As illustrated in FIG. 16, a kiosk/LFD providing arrival information, for example, may be assigned a dynamic identifier of “LFD-Arrival” 1601. Likewise, another kiosk/LFD providing departure information, for example, may be assigned a dynamic identifier of “LFD-Departure” 1602. Yet another kiosk/LFD that provides promotion information may be assigned a dynamic identifier of “LFD-Promotion” 1603, and so on. By doing so, any user who is within the wireless range of the various kiosks/LFDs can receive the necessary data and need not be in the visual range of the kiosks/LFDs. In addition, when one of the kiosk or LFD changes its displayed content (e.g., arrivals to departures), the dynamic identifier of the device may also change accordingly.

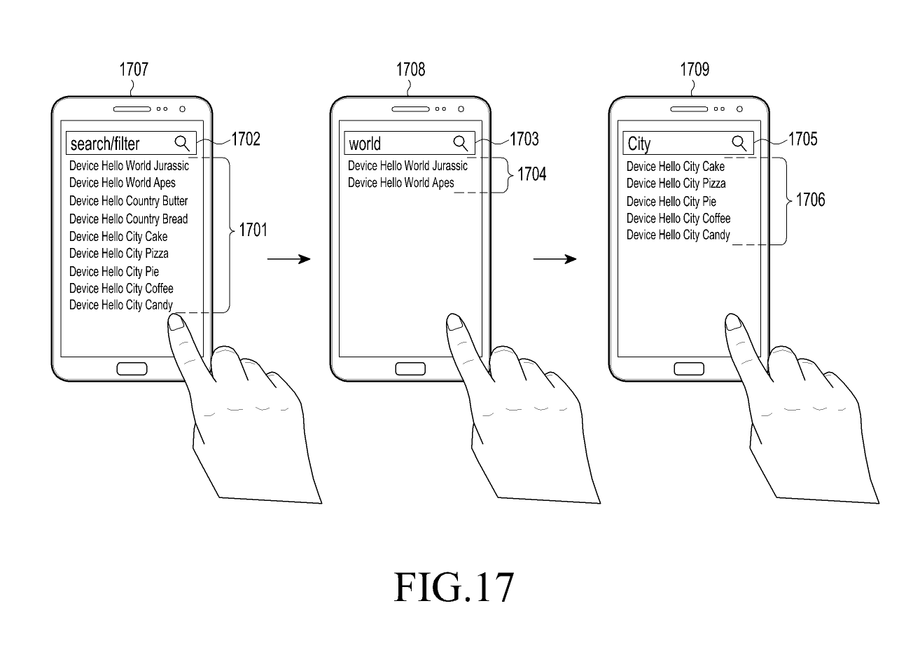

FIG. 17 illustrates yet another scenario in which devices may be searched and filtered based on dynamic identifiers received. At the recipient device side, a user may filter devices based on keywords. For example, a recipient device 1707 may receive dynamic identifiers from a plurality of devices 1701. The recipient device 1707 may include an option for performing a search 1702. When the user performs a search 1703, the recipient device 1708 may now depict dynamic identifiers 1704 of the devices that satisfy the search query 1703. The user at the recipient device 1709 can perform a different search 1705, and the recipient device 1709 may display dynamic identifiers 1706 of only those devices that satisfy the search query 1705.

In yet another example, a user having a seeking device obtain information about what television program is being displayed on a television set in an adjacent room without actually visiting the room because the content information will be available as part of the name of the TV when the user browses the available Bluetooth/Wi-Fi devices in the vicinity. The dynamic identifier may also be used to provide parental guidelines information (e.g., TV-G, TV-Y, TV-14, TV-MA, G, PG, PG-13, R, etc.) of the programming. Parents can thus monitor what is being watched on the TV without being present in the room where the TV is located.

While specific language has been used to describe the disclosure, any limitations arising on account of the same are not intended. As would be apparent to a person in the art, various working modifications may be made to the method in order to implement the embodiments as taught herein.

The figures and the foregoing description give examples of various embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the embodiments is by no means limited by these specific examples. Numerous variations, whether explicitly given in the specification or not, such as differences in structure, dimension, and use of material, are possible. The scope of the embodiments is at least as broad as given by the following claims.

We claim:

1. A method of assigning an identifier to one of an electronic device and a connection offered by the electronic device, the method comprising:
detecting at least one of content information pertaining to content being offered by the electronic device, service information pertaining to a service being offered by the electronic device, and application information pertaining to an application running on the electronic device; and
providing the identifier to one of the electronic device and the connection offered by the electronic device, the identifier being based on at least one of the content information, the service information, and the application information.

2. The method as claimed in claim 1, further comprising detecting at least one multimedia application running on the electronic device, the at least one multimedia application offering one of content and the service.

3. The method as claimed in claim 1, wherein the identifier is further based on at least one of a location of the electronic device, priority information, type of the electronic device, and a version of software installed on the electronic device.

4. The method as claimed in claim 1, wherein one of the content information and the service information pertains to at least one of metadata about the content, electronic program guide data of the content, a type of the service, and a status of the service.

5. The method as claimed in claim 1 further comprising detecting nomenclature of one or more adjacently located devices.

6. The method as claimed in claim 5, wherein the identifier provided to the electronic device is further based on another identifier of another device located within a threshold distance from the electronic device.

7. The method as claimed in claim 1, further comprising transmitting the identifier of the electronic device to at least one device requesting to establish a connection with the electronic device.

8. The method as claimed in claim 5, further comprising performing, based on at least one of the identifier and the other identifier, at least one of:
controlling an operation of the electronic device; and
executing a functionality at the electronic device.

9. The method as claimed in claim 1, further comprising:
detecting whether the identifier provided to the electronic device complies with a rule in relation to identifier of the electronic device; and
providing a revised identifier to the electronic device, in response to the identifier provided to the electronic device not complying with the rule, the revised identifier being based on parsed content or service information offered by the electronic device.

10. The method as claimed in claim 9, further comprising transmitting the revised identifier of the electronic device to at least one device requesting to establish a connection with the electronic device.

11. The method as claimed in claim 1, further comprising performing, based on at least one of the revised identifier and another identifier of another device, at least one of:
controlling an operation of the electronic device; and
executing a functionality of the electronic device.

12. An electronic device comprising:
a communication interface configured to transmit discovery information about the electronic device to at least one other device, the discovery information comprising an identifier assigned to one of the electronic device and a connection offered by the electronic device, and the identifier being based on at least one of content offered by the electronic device, a service offered by the electronic device, and an application running on the electronic device.

13. The electronic device as claimed in claim 12, further comprising a synchronization module configured to:
detect at least one of:
a multimedia application running on the electronic device, the multimedia application offering one of the content and the service,
a first change in the content being offered by the electronic device,
a second change in the service offered by the electronic device, and
a third change in the application running on the electronic device; and
generate a corresponding trigger.

14. The electronic device as claimed in claim 13, further comprising a content and service status information determining module in operational interconnection with the synchronization module, the content and service status information determining module being configured to receive the corresponding trigger and generate at least one of content information pertaining to the content offered by the electronic device, service information pertaining to the service offered by the electronic device, and application information pertaining to the application running on the electronic device.

15. The electronic device as claimed in claim 14, further comprising a dynamic name processing module comprising a name synthesizer module, the dynamic name processing module being in operational interconnection with the content and service status information determining module, and configured to:
receive, from the content and service status information determining module, at least one of the content information, the service information, and the application information, and
provide an identifier to one of the electronic device and a connection offered by the electronic device.

16. The electronic device as claimed in claim 12, wherein the communication interface comprises a device/connection name module configured to transmit discovery information about the electronic device to at least one other device.

17. The electronic device as claimed in claim 16, wherein the device/connection name module is further configured to receive another identifier of a device located within a threshold distance from the electronic device.

18. The electronic device as claimed in claim 17, wherein the device/connection name module is in operational interconnection with the dynamic name processing module and is configured to provide to the dynamic name processing module the other identifier.
